(19) United States
(12) Patent Application Publication
(10) Pub. No.: US 2006/0020976 A1
(43) Pub. Date: Jan. 26, 2006

(54) Television broadcast signal receiving system

(75) Inventors: Toshihiro Takagi, Osaka (JP); Shusuke Narita, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/175,218

(22) Filed: Jul. 7, 2005

(30) Foreign Application Priority Data
Jul. 8, 2004 (JP) 2004-201709

(51) Int. Cl. H04N 7/20

(52) U.S. Cl. 725/72

(57) ABSTRACT

In a TV broadcast signal receiving system, setting up of a multi-directional antenna and a TV broadcast signal receiver is made simple and easy. The multi-directional antenna identifies a standard direction used as a standard for receiving a TV broadcast signal, at least latitude and longitude of a location of the multi-directional antenna. The TV broadcast signal receiver memorizes TV tower information including position information of latitudes and longitudes of positions of a plurality of TV towers and channel information of channels, TV broadcast signals of which are transmitted from each TV tower. The TV broadcast signal receiver decides an optimum signal receiving direction of each receivable channel with using the antenna information and the TV tower information, which is used for switching an effective signal receiving direction of the multi-directional antenna for receiving a TV broadcast signal of an optional channel chosen by a user.

### BACKGROUND OF THE INVENTION

1. Field of the Invention

The present invention relates to a television broadcast signal receiving system for receiving television broadcast signals delivered from a plurality of directions.

2. Description of the Related Art

In the North American Continent where an ATSC digital television broadcast (it is abbreviated to a hereinafter digital TV broadcast) is performed, plains are dotted with metropolises, so that various digital TV broadcast signals broadcasted in the suburbs of each metropolis can be received at other cities or the halfway point of the cities. In consideration from a user who receives the TV broadcast signals, since many TV broadcast signals are transmitted in various directions, it is necessary to regulate a direction of an antenna in an orientation to a TV broadcasting station from which a program which he wants to watch is delivered. Therefore, a multi-directional antenna such as a smart antenna is put into practical use.

According to the EIA-909 technical standard, it is provided that a smart antenna has sixteen signal receiving directions in respective directions where a circle is divided into sixteen. A television broadcast signal receiver connected to such a multi-directional antenna is capable of adjusting an effective signal receiving direction of the multi-directional antenna.

As for an antenna which can receive the electric waves in a plurality of directions, the documents of Japanese Laid-Open Patent Publications No. 2001-203527, No. 2002-198878 and No. 2003-529262 are known.

The above-mentioned multi-directional antenna such as a smart antenna can change the signal receiving direction by selecting only one signal receiving direction among sixteen signal receiving directions, so that the multi-directional antenna can be located with no relation to the orientation thereof. However, when the multi-directional antenna is located without adjusting the orientation of the antenna to a standard direction, it is impossible to identify each of sixteen signal receiving directions of the multi-directional antenna corresponds to actual azimuth. Therefore, even when the direction of TV towers from which TV broadcast signals are delivered are known in a TV broadcast signal receiver side, it is impossible to switch an effective signal receiving direction of the multi-directional antenna from the TV broadcast signal receiver With using the information of locations of the TV towers.

Furthermore, it is very troublesome to switch the effective signal receiving direction of the multi-directional antenna by manual operation of a user with respect to each channel delivered from each TV tower. On the other hand, there are some TV broadcast signal receivers which have an automatic scanning function for automatically selecting an optimum signal receiving direction of a channel chosen by a user, in which the TV broadcast signal of the channel can be received in the most suitable condition. Such a TV broadcast signal receiver having the automatic scanning function, however, scans all signal receiving directions of the multi-directional antenna with respect to all receivable channels, so that it wastes a long term for deciding the optimum signal receiving directions for all receivable channels.

### SUMMARY OF THE INVENTION

A first purpose of the present invention is to provide a television broadcast signal receiving system, in which optimum signal receiving directions of receivable channels can easily be set when a multi-directional antenna and a TV broadcast signal receivers are set up. A second purpose of the present invention is to provide a television broadcast signal receiving system, by which an effective signal receiving direction of a multi-directional antenna can automatically be decided when a TV broadcast signal of a predetermined channel is received.

A television broadcast signal receiving system in accordance with an aspect of the present invention comprises a multi-directional antenna having a plurality of signal receiving directions previously defined and a television broadcast signal receiver connected to the multi-directional antenna for receiving a television broadcast signal.

The multi-directional antenna has a standard direction identifying means for identifying a standard direction used as a standard for receiving a television broadcast signal.

The television broadcast signal receiver has a television tower direction identifying means for identifying directions of television towers relative to a location of the multi-directional antenna with respect to the standard direction, and an optimum signal receiving direction deciding means for deciding optimum signal receiving directions of receivable channels which are used for switching an effective signal receiving direction of the multi-directional antenna for receiving a television broadcast signal of an optional channel chosen by a user with using the directions of the television towers.

By such a configuration, the standard direction of the multi-directional antenna can be identified specifically, so that a user can easily set optimum signal receiving directions of receivable channels into the television broadcast signal receiver.

For setting the optimum signal receiving directions of the receivable channels by manual operation of a user, it is sufficient that the standard direction identifying means of the multi-directional antenna is a mark provided on a main body of the multi-directional antenna, which is used so that the mark is oriented to a predetermined standard direction of actual azimuth; and the television tower direction identifying means is a display for displaying an image showing signal receiving directions of the multi-directional antenna and a remote controller used for selecting one among the signal receiving directions of the multi-directional antenna.

By such a configuration, the multi-directional antenna and the television broadcast signal receiver can be made simple and inexpensive.

Alternatively, for setting the optimum signal receiving directions of the receivable channels automatically, it is sufficient that the multi-directional antenna further has a location of multi-directional antenna identifying means for identifying at least latitude and longitude of a location of the multi-directional antenna, and an antenna information output means for outputting antenna information including the latitude and the longitude of the location of the multi-directional antenna; the television broadcast signal receiver further has an antenna information input means for inputting the antenna information, and a television tower information memory means for memorizing television tower information including position information relating to positions of a plurality of television towers and channel information relating to channels, television signals of which are transmitted from each television towers; and the television tower direction identifying means identifies the directions of the television towers relative to the location of the multi-directional antenna with respect to the standard direction with using the antenna information and the television tower information.

By such a configuration, the setting up of the multi-directional antenna and the television broadcast signal receiver can be made simple and easy.

Furthermore, a television broadcast signal receiver in accordance with an aspect of the present invention comprises: an input means used for inputting antenna information including at least latitude and longitude of a location of a multi-directional antenna connected to the television broadcast signal receiver; a memory for memorizing television tower information including position information relating to positions of a plurality of television towers and channel information relating to channels, television signals of which are transmitted from each television towers; a control means for identifying directions of television towers relative to a location of the multi-directional antenna with respect to a standard direction with using the antenna information and the television tower information, and for deciding optimum signal receiving directions of receivable channels which are used for switching an effective signal receiving direction of the multi-directional antenna for receiving a television broadcast signal of an optional channel chosen by a user with using the directions of the television towers.

By such a configuration, when a user can know, for example, the latitude and the longitude of the location of the multi-directional antenna by any method, the television broadcast signal receiver can automatically set the optimum signal receiving directions of the receivable channels.

### BRIEF DESCRIPTION OF THE DRAWINGS

FIG. 1 is a conceptual diagram showing a circumstance for receiving digital television broadcast, signals in home;

FIG. 2 is a block diagram showing a configuration of a television broadcast signal receiving system in accordance with a first embodiment of the present invention;

FIG. 3 is a top view of an example of a multi-directional antenna used in the system of the first embodiment;

FIG. 4 is a flowchart showing a process for setting optimum signal receiving directions of receivable channels into a TV broadcast signal receiver used in the system of the first embodiment;

FIG. 5A is a drawing showing an image displayed on a screen of a monitor display for setting the optimum signal receiving directions of the receivable channels with using information of locations of TV towers;

FIG. 5B is a plan view of a remote controller used for setting the optimum signal receiving directions of the receivable channels;

FIG. 6 is a block diagram showing a configuration of a television broadcast signal receiving system in accordance with a second embodiment of the present invention;

FIG. 7 is a drawing showing an example of a TV tower information table including position information relating to positions of the TV towers existing at many positions and channel information relating to channels delivered from each of the TV towers used in the system of the second embodiment;

FIG. 8 is a flowchart showing a process for setting up of the multi-directional antenna in the system of the second embodiment;

FIG. 9 is a top view of another example of a multi-directional antenna used in the system of the second embodiment;

FIG. 10 is a flowchart showing a process for setting up a TV broadcast signal receiver in the system of the second embodiment; and

FIG. 11 is a drawing showing an example of a signal receiving direction table formed in the process for setting up the TV broadcast signal receiver in the second embodiment.

### DETAILED DESCRIPTION OF THE EMBODIMENT

A television (TV) broadcast signal receiving system in accordance with a first embodiment of the present invention is described with reference to figures.

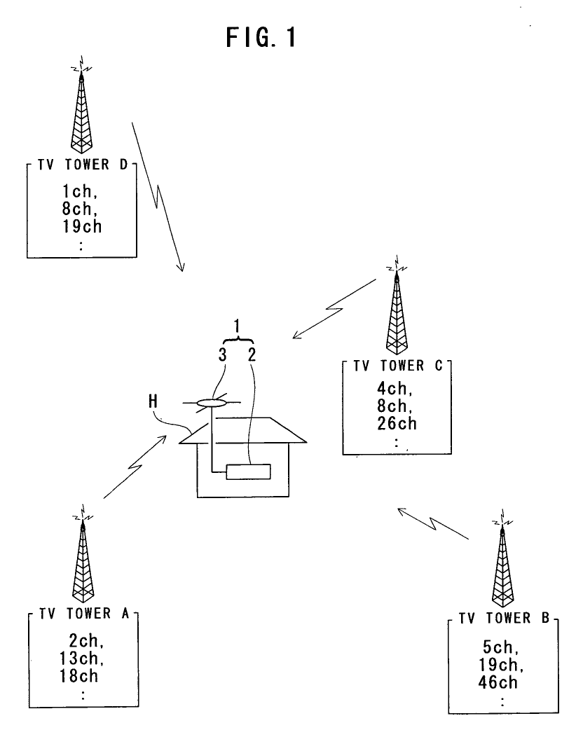

A circumstance for receiving TV broadcast signals in home is shown in FIG. 1. In an area where grand-based digital TV broadcast is performed, when an intensity of received signal of a digital TV broadcast signal is equal to or larger than a predetermined threshold value, an image having a predetermined image quality can be obtained by correction. Thus, it is possible to view TV programs by receiving TV broadcast signals which are delivered from TV stations A to D existing at many positions in such as an area designated by a symbol H, as shown in FIG. 1. According to such a circumstance, various types of multi-directional antennas called smart antenna having a plurality of signal receiving directions are put into practical use.

The TV broadcast signal receiving system 1 comprises a TV broadcast signal receiver 2 and a multi-directional antenna 3. The TV broadcast signal receiver 2 can selectively receive a TV broadcast signal of a channel among many channels delivered from the TV towers A to D by switching an effective signal receiving direction of the multi-directional antenna 3, and outputs the received TV broadcast signal to a monitor display. In this description, a physical channel which is a frequency bandwidth of carrier wave used for transmitting the TV broadcast signal is merely called as a channel.

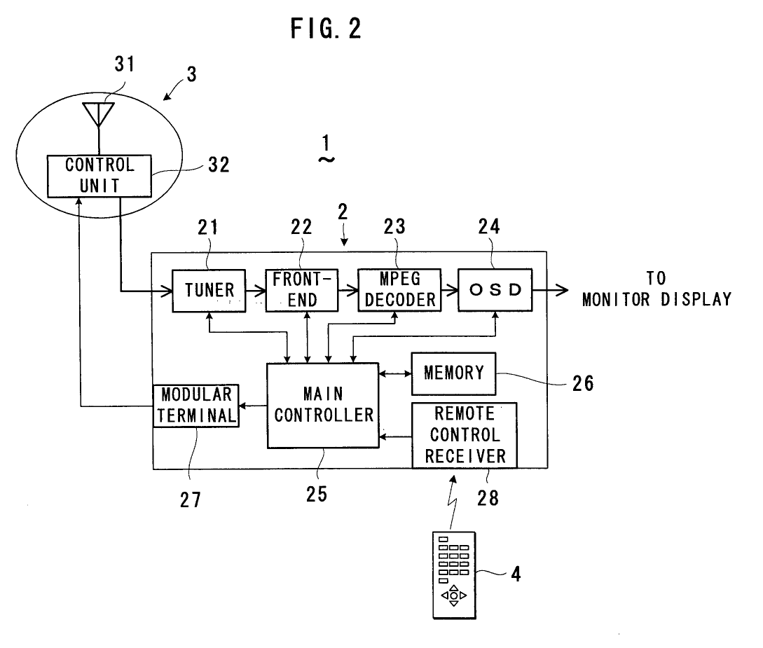

FIG. 2 shows an example of a configuration of the TV broadcast signal receiving system 1. As shown in FIG. 2, the TV broadcast signal receiver 2 is comprised of a tuner 21 connected to the multi-directional antenna 3 and receiving a TV broadcast signal, a front end 22 performing a predetermined signal processing to the TV broadcast signal received by the tuner 21 for decoding the TV broadcast signal, an MPEG decoder 23 decoding the TV broadcast signal compressed in compliance with the MPEG standard, an on screen display (OSD) unit 24 superimposing a data of predetermined display image on the decoded TV broadcast signal, a main controller 25 sensing a signal receiving condition of the TV broadcast signal, outputting an antenna control signal for controlling a control unit 32 of the multi-directional antenna 3, and controlling the entire of the TV broadcast signal receiver 2, a memory 26 memorizing a table of signal receiving directions and so on, a modular terminal 27, and a remote control signal receiver 28 for receiving a signal outputted from a remote controller 4 and outputting the received signal to the main controller 25. The TV broadcast signal decoded by the MPEG decoder 23 is outputted to a monitor display through the OSD unit 24 so that an image is displayed on the monitor display with using the TV broadcast signal.

The table of signal receiving directions memorized in the memory 26 includes information of channel numbers delivered from the TV towers A to D, and information relating to optimum signal receiving directions of receivable channels which are used for switching the effective signal receiving direction of the multi-directional antenna 3 when a TV broadcast signal of an optional channel chosen by a user is received.

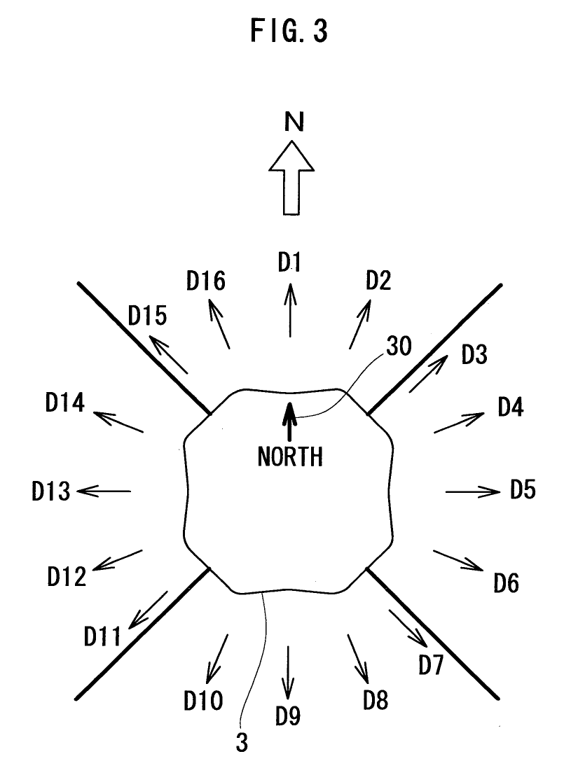

The multi-directional antenna 3 which is called smart antenna comprises an antenna unit 31 for receiving TV broadcast signal and a control unit 32 for controlling the motion of the antenna unit 31. The antenna unit 31 has, for example, sixteen signal receiving directions D1 to D16 as shown in FIG. 3, and an effective signal receiving direction is selected among these sixteen signal receiving directions by electrically switched on and off of electronic switches or mechanically moving an antenna (these elements are not shown). The electronic switches or a controller for moving the antenna serves as a switch for switching the effective signal receiving direction of the multi-directional antenna 3. The control unit 32 makes an indicated signal receiving direction effective among the signal receiving directions D1 to D16 of the antenna unit 31 corresponding to the inputted antenna control signal.

As shown in FIG. 3, a mark 30 for identifying a standard direction, which is used for locating the multi-directional antenna 3, is provided on a top face of a main body of the multi-directional antenna 3. In this example, the main body of the multi-directional antenna 3 is located so that the mark 30 is oriented to be coincided with north. FIG. 3 shows a case that the signal receiving direction D1 and the standard direction N are coincided with each other.

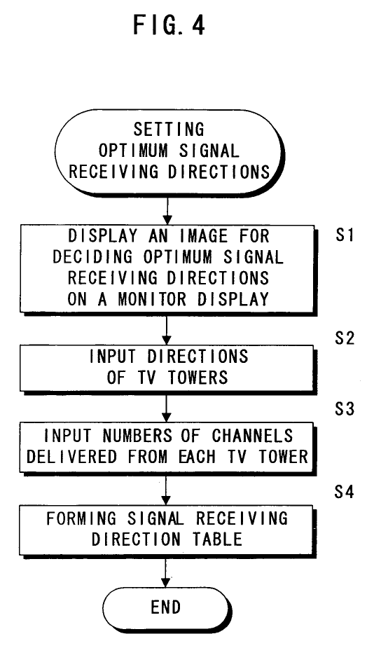

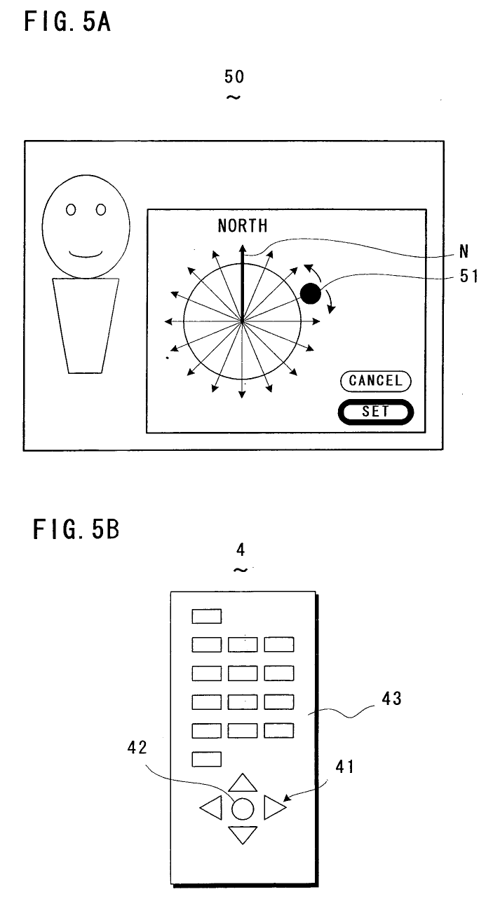

Subsequently, a process for setting optimum signal receiving direction of receivable channels which are used for switching the effective signal receiving direction of the multi-directional antenna 3 for receiving a TV broadcast signal of an optional channel by a manual operation of the user is described with reference FIGS. 4, 5A and 5B.

When the process for setting the optimum signal receiving direction of all the receivable channels is started by an operation of the remote controller 4 of the user, the TV broadcast signal receiver 2 outputs an image data to the monitor display, so that an image 50 for deciding the optimum signal receiving direction as shown in FIG. 5A is displayed on a screen of the monitor display (S1). Then, the TV broadcast signal receiver 2 accepts input of directions of TV towers by the user (S2). Specifically, the user operates arrow pads 41 of the remote controller 4 shown in FIG. 5B. Since a cursor 51 displayed on the screen moves on the image 50 corresponding to the operation of the arrow pads 41, the user moves the cursor 51 to a position showing a direction toward a TV tower. When the user operates a decision key pad 42, the direction shown by the cursor 51 is registered as a direction of a TV tower. By repeating such operations, a plurality of directions of TV towers are registered in the TV broadcast signal receiver 2.

Subsequently, the TV broadcast signal receiver 2 accepts input of numbers of channels delivered from each TV towers by the user (S3). Specifically, the user operates numeric key pads 43 and the decision key pad 42 of the remote controller 4 for inputting a number of a channel, while one direction among the directions of the TV towers is selected. Hereupon, it is assumed that the user knows the directions of the TV towers and the channel numbers delivered from each of the TV towers. By repeating such operations with respect to all receivable channels, the optimum signal receiving directions of all receivable channels are inputted to the TV broadcast signal receiver 2. The TV broadcast signal receiver 2 forms a signal receiving direction table showing relations between the optimum signal receiving directions of receivable channels and the channel numbers, and memorizes the table into the memory 26 (S4).

When the user chooses a channel, the main controller 25 reads out the optimum signal receiving direction of the chosen channel from the table memorized in the memory 26, and outputs a control signal for indicating the optimum signal receiving direction of the chosen channel to the multi-directional antenna 3.

When the multi-directional antenna 3 is located on the bases of the mark 30, it is possible to identify each of the sixteen signal receiving directions of the multi-directional antenna 3 with actual azimuth. Thus, the user can easily set the optimum signal receiving directions of all receivable channels with using the information of location of TV towers and the information of channel numbers delivered from each of the TV towers at the setting up of the multi-directional antenna 3 and the TV broadcast signal receiver 2.

Subsequently, a TV broadcast signal receiving system in accordance with a second embodiment of the present invention is described with reference to figures. The TV broadcast signal receiving system 1 in the second embodiment is different from that in the first embodiment at a point that the optimum signal receiving directions of the receivable channels are automatically set.

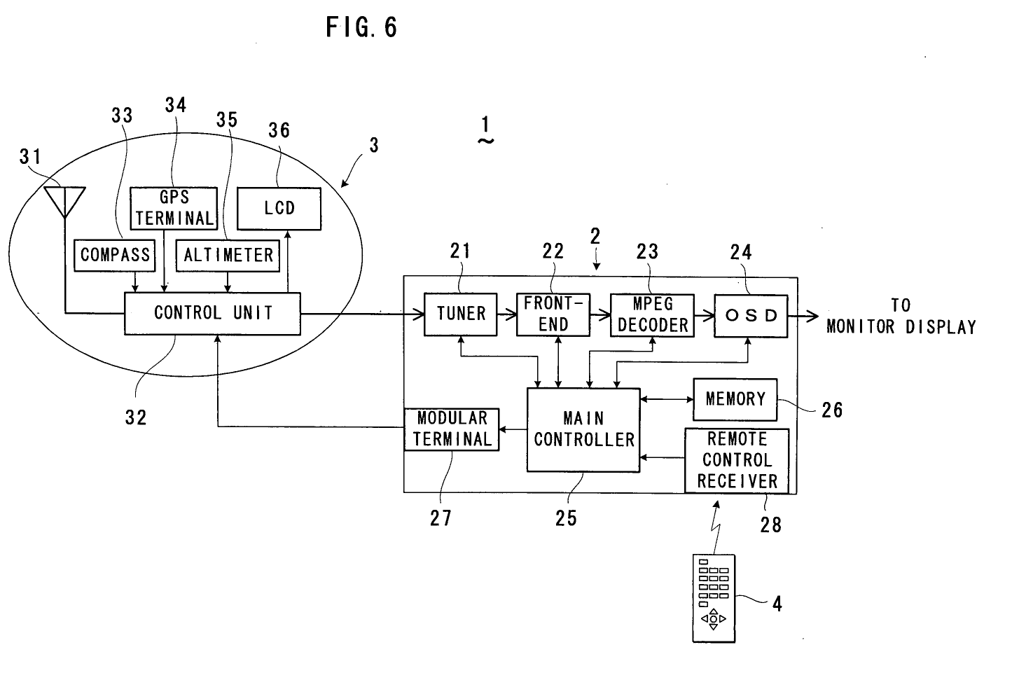

FIG. 6 shows an example of a configuration of the TV broadcast signal receiving system 1. As shown in FIG. 6, the multi-directional antenna 3 comprises a compass 33, a GPS (Global Positioning System) terminal 34, an altimeter 35 and an LCD (Liquid Crystal Display) 36 further to the antenna unit 31 and the control unit 32. The compass 33 identifies a standard direction serving as a standard for receiving the TV broadcast signals and outputs a signal corresponding to the standard direction to the control unit 32. The GPS terminal 34 identifies latitude and longitude of the location of the multi-directional antenna 3 and outputs signals corresponding to the latitude and the longitude to the control unit 32. The altimeter 35 identifies altitude of the location of the multi-directional antenna 3 and outputs a signal corresponding to the altitude to the control unit 32. The LCD 36 displays antenna information including the standard direction, the latitude, longitude and altitude of the location of the multi-directional antenna 3, and a kind and a size of the multi-directional antenna 3.

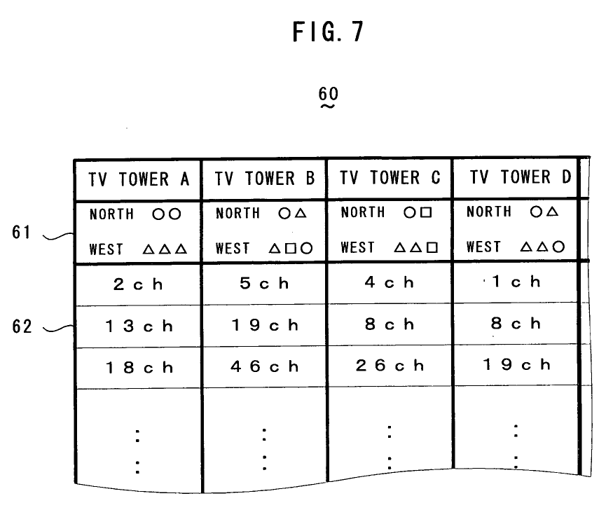

Subsequently, a TV tower information table 60 memorized in the memory 26 of the TV broadcast signal receiver 2 is described with reference to FIG. 7. The TV tower information table 60 includes position information 61 relating to positions of the TV towers existing at many positions and channel information 62 relating to channels delivered from each of the TV towers. In the example of the TV tower information table 60 shown in FIG. 7, only the position information 61 and the channel information 62 of the TV towers A to D are shown, and those of the others are omitted. The position information 61 includes information relating to the latitudes and the longitudes of the positions of the TV towers A to D. The channel information 62 includes information relating to a plurality of channels (channel groups) TV broadcast signals of which are transmitted from the TV towers A to D. In the example shown in FIG. 7, it is shown that the TV tower transmits the TV broadcast signals of a second channel (2ch), a thirteenth channel (13ch), an eighteenth channel (18ch), and so on.

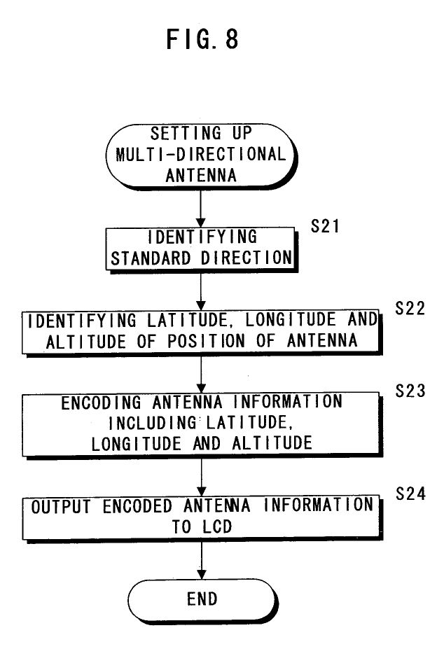

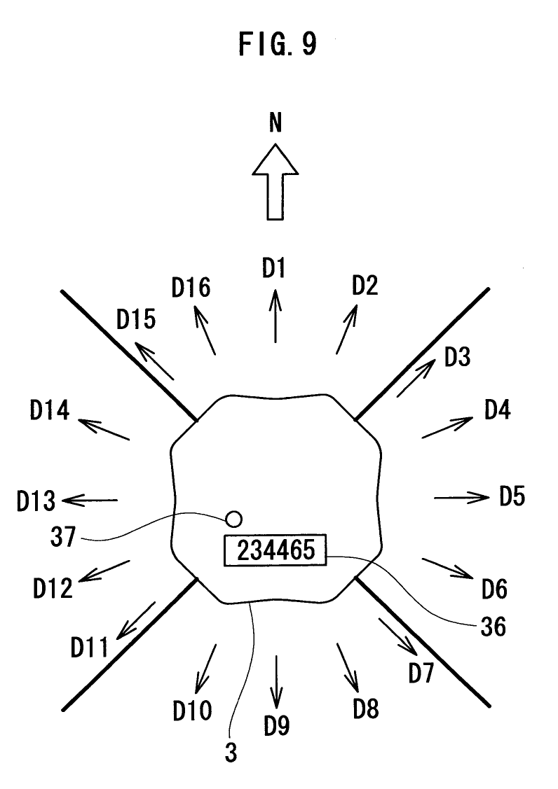

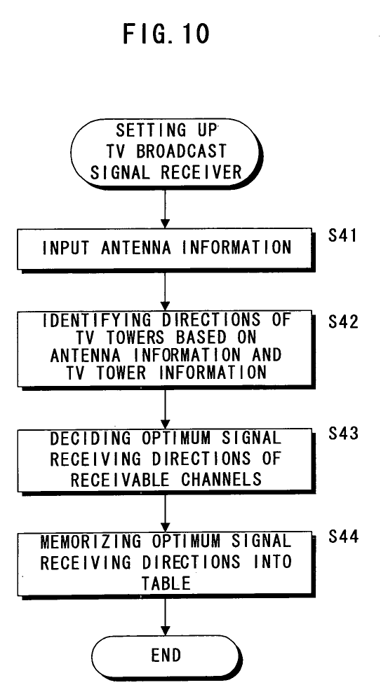

Subsequently, a process for setting up the multi-directional antenna 3 is described with reference to FIGS. 8 and 9. FIG. 8 shows a flowchart of the process for setting up the multi-directional antenna 3. FIG. 9 shows a top face of the multidirectional antenna 3 used in the system of the second embodiment.

After locating the multi-directional antenna 3, when the user switches on a set up switch 37 provided on a top face of the multi-directional antenna 3, the compass 33 identifies the standard direction N and outputs the signal corresponding to the standard direction N to the control unit (S21). Subsequently, the GPS terminal 34 and the altimeter 35 measure the latitude, the longitude and the altitude of the location of the multi-directional antenna 3 and input the signals corresponding to them are inputted to the control unit 32 (S22). The control unit 32 encodes the standard direction N, the latitude, longitude and altitude of the location of the multi-directional antenna 3 and the kind and size of the multi-directional antenna 3 (S23), and outputs them to the LCD 36 (S24). The LCD 36 displays the antenna information inputted from the control unit 32 on a screen thereof, as shown in FIG. 9.

Subsequently, a process for setting up the TV broadcast signal receiver 2 is described with reference 10. After setting the TV broadcast signal receiver 2, the user operates the remote controller 4 so as to input the antenna information displayed on the LCD 36 (S41). The main controller 25 identifies directions of the TV towers relative to the location of the multi-directional antenna 3 with respect to the standard direction N with using the information relating to the location of the multi-directional antenna 3 inputted by the user and the position information 61 included in the TV tower information table 60 (S42). Then, the main controller 25 decides the optimum signal receiving directions of the receivable channels with reference to the channel information 62 included in the TV tower information table 60 (S43). Hereupon, a single optimum signal receiving direction is decided with respect to a plurality of channels or a channel group, TV broadcast signals of which are transmitted from the same TV tower. The main controller 25 forms a signal receiving direction table 70 including the optimum signal receiving directions of each of the receivable channels or the optimum signal receiving directions of each of the channel groups, and memorizes the signal receiving direction table 70 into the memory 26 (S44).

When the main controller 25 performs the process for setting up the TV broadcast signal receiver 2, it identifies the directions toward the TV towers and decides the optimum signal receiving directions of the receivable channels automatically.

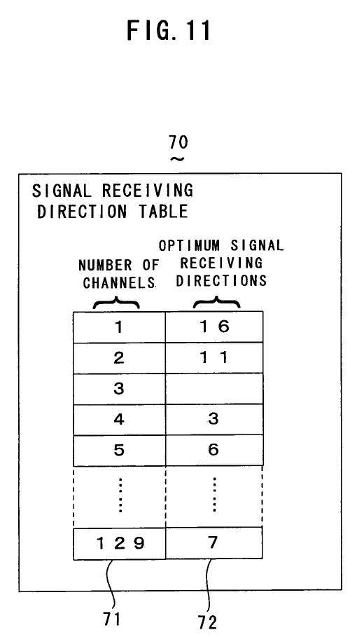

FIG. 11 shows an example of the signal receiving direction table 70 formed in the above-mentioned process for setting up the TV broadcast signal receiver 2. The signal receiving direction table 70 includes the optimum signal receiving directions 72 of the receivable channel corresponding to channel numbers 71. In FIG. 11, the numerals shown in the boxes of the optimum signal receiving directions 72 correspond to the signal receiving direction D1 to D16 of the multi-directional antenna 3 shown in FIG. 9. For example, the numeral 16 corresponds to the signal, receiving direction D16, the numeral 11 corresponds to the signal receiving direction D11, and so on. When the user chooses an optional channel, the main controller 25 reads out the optimum signal receiving direction of the chosen channel from the signal receiving direction table 70, and outputs a control signal indicating the optimum signal receiving direction to the multi-directional antenna 3. The effective signal receiving direction of the multi-directional antenna 3 is switched to the signal receiving direction indicated by the control signal, so that the TV broadcast signal of the chosen channel can be received in the most suitable direction, that is, the direction of the TV tower from which the TV broadcast signal is transmitted.

According to the TV broadcast signal receiving system 1 in accordance with the second embodiment, the multi-directional antenna 3 comprises the compass for identifying the standard direction N, the GPS terminal 34 for identifying the latitude and longitude of the location of the multi-directional antenna 3, the altimeter 35 for identifying the altitude of the location of the multi-directional antenna 3 and the LCD for displaying the antenna information, and the TV broadcast signal receiver 2 comprises the remote controller 4 used for inputting the antenna information and the memory 26 for memorizing the TV tower information table 60. Thus, it is possible to identify the direction of the TV towers relative to the location of the multi-directional antenna 3 and to decide the optimum signal receiving directions of the receivable channels automatically with using there information. Furthermore, the TV broadcast signal receiver 2 performs no automatic scanning for deciding the optimum signal receiving directions of the receivable channels, so that it is possible to shorten a time necessary for setting up the TV broadcast signal receiver 2 and the multi-directional antenna.

The present invention is not limited to the above-mentioned description of the embodiments, and various modifications can be carried out. For example, it is possible to transmit the antenna information directly from the multi-directional antenna 3 to the TV broadcast signal receiver 2 via a wireless or wired communication. Furthermore, the TV broadcast signals receivable by the TV broadcast signal receiving system 1 is not limited to only the digital TV broadcast signal, but analogue TV broadcast signals. Still furthermore, the number of the signal receiving directions of the multi-directional antenna 3 is not limited to only sixteen, it is possible to have four, eight, or other number of the signal receiving direction is applicable.

This application is based on Japanese patent application 2004-201709 filed Jul. 8, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A television broadcast signal receiving system comprising a multi-directional antenna having a plurality of signal receiving directions previously defined and a television broadcast signal receiver connected to the multi-directional antenna for receiving a television broadcast signal, wherein
the multi-directional antenna has a standard direction identifying means for identifying a standard direction used as a standard for receiving a television broadcast signal; and
the television broadcast signal receiver has a television tower direction identifying means for identifying directions of television towers relative to a location of the multi-directional antenna with respect to the standard direction, and an optimum signal receiving direction deciding means for deciding optimum signal receiving directions of receivable channels which are used for switching an effective signal receiving direction of the multi-directional antenna for receiving a television broadcast signal of an optional channel chosen by a user with using the directions of the television towers.

2. The television broadcast signal receiving system in accordance with claim 1, wherein
the standard direction identifying means of the multi-directional antenna is a mark provided on a main body of the multi-directional antenna, which is used so that the mark is oriented to a predetermined standard direction of actual azimuth; and
the television tower direction identifying means is a display for displaying an image showing signal receiving directions of the multi-directional antenna and a remote controller used for selecting one among the signal receiving directions of the multi-directional antenna.

3. The television broadcast signal receiving system in accordance with claim 1, wherein
the multi-directional antenna further has a location of multi-directional antenna identifying means for identifying at least latitude and longitude of a location of the multi-directional antenna, and an antenna information output means for outputting antenna information including the latitude and the longitude of the location of the multi-directional antenna;
the television broadcast signal receiver further has an antenna information input means for inputting the antenna information, and a television tower information memory means for memorizing television tower information including position information relating to positions of a plurality of television towers and channel information relating to channels, television signals of which are transmitted from each television towers; and
the television tower direction identifying means identifies the directions of the television towers relative to the location of the multi-directional antenna with respect to the standard direction with using the antenna information and the television tower information.

4. The television broadcast signal receiving system in accordance with claim 3, wherein
the location of multi-directional antenna identifying means of the multi-directional antenna further identifies altitude of the location of the multi-directional antenna.

5. The television broadcast signal receiving system in accordance with claim 3, wherein
the television tower information includes latitudes and longitudes of the positions of the television towers.

6. The television broadcast signal receiving system in accordance with claim 3, wherein
the antenna information output means is a display for encoding and displaying the antenna information; and
the antenna information input means is a remote controller operated by a user for inputting the antenna information displayed on the display.

7. The television broadcast signal receiving system in accordance with claim 3, wherein
the antenna information output means is a transmitter for encoding and transmitting the antenna information; and
the antenna information input means is a receiver for receiving and decoding the antenna information transmitted from the transmitter via a wireless or wired transmission.

8. A television broadcast signal receiving system comprising a multi-directional antenna having a plurality of signal receiving directions previously defined and a television broadcast signal receiver connected to the multi-directional antenna for receiving a television broadcast signal, wherein
the multi-directional antenna comprises:
a compass for identifying a standard direction used as a standard for receiving a television broadcast signal;
a GPS (Global Positioning System) terminal for identifying latitude and longitude of a location of the multi-directional antenna;
an altimeter for identifying altitude of the location of the multi-directional antenna; and
a display for encoding and displaying antenna information including the standard direction, the latitude, longitude and altitude of the location of the multi-directional antenna, and a kind and a size of the multi-directional antenna; and
the television broadcast signal receiver comprises:
a remote controller used for inputting the antenna information;
a memory for memorizing television tower information including position information relating to positions of a plurality of television towers and channel information relating to channels, television signals of which are transmitted from each television towers;
a main controller for identifying directions of television towers relative to a location of the multi-directional antenna with respect to the standard direction with using the antenna information and the television tower information, and for deciding optimum signal receiving directions of receivable channels which are used for switching an effective signal receiving direction of the multi-directional antenna for receiving a television broadcast signal of an optional channel chosen by a user with using the directions of the television towers.

9. A television broadcast signal receiver comprising:
an input means used for inputting antenna information including at least latitude and longitude of a location of a multi-directional antenna connected to the television broadcast signal receiver;
a memory for memorizing television tower information including position information relating to positions of a plurality of television towers and channel information relating to channels, television signals of which are transmitted from each television towers;
a control means for identifying directions of television towers relative to a location of the multi-directional antenna with respect to a standard direction with using the antenna information and the television tower information, and for deciding optimum signal receiving directions of receivable channels which are used for switching an effective signal receiving direction of the multi-directional antenna for receiving a television broadcast signal of an optional channel chosen by a user with using the directions of the television towers.
